(19) United States
(12) Patent Application Publication
(10) Pub. No.: US 2022/0246314 A1
(43) Pub. Date: Aug. 4, 2022

(54) 210Pb and 227Ac Precursor Isotopes in Radioisotope Power Systems

(71) Applicant: Marshall G. Millett, Annapolis, MD (US)

(72) Inventor: Marshall G. Millett, Annapolis, MD (US)

(21) Appl. No.: 17/167,139

(22) Filed: Feb. 4, 2021

(51) Int. Cl. G21C 3/58; G21C 3/12; G21C 3/28; G21C 3/07

(52) U.S. Cl. CPC G21C 3/58; G21C 3/07; G21C 3/28; G21C 3/12

(57) ABSTRACT

²¹⁰Pb and ²²⁷Ac are used in thermal energy production as precursor isotopes, which have been isolated and are allowed to age to the point of secular equilibrium with their progeny, referring to the decay product isotopes in the radioactive decay chain of each. Both ²¹⁰Pb and ²²⁷Ac are in the radioactive decay chains of naturally occurring uranium isotopes, and are each subject to their own natural radioactive decay. While not particularly energetic through their own decay, they (1) are separable from their parent isotopes or may be created in a reactor, (2) have half-lives of around 22 years, and (3) are precursors (natural radioactive decay parents) to subsequent rapid and energetic decay processes. These two isotopes can offer significant advantages as RPS fuel compared to the currently used ²³⁸Pu.

### TECHNICAL FIELD

The present disclosure relates to radioactive isotopes for a Radioisotope Power System (RPS). More particularly, the present disclosure relates to the use of particular isotopes in secular equilibrium with their decay products for providing thermal energy.

### BACKGROUND

The nuclear decay of radioactive isotopes provides energetic particles and photons that may be captured for conversion to useful energy forms. The use of nuclear decay energy allows the production of power supplies that are long lived, where the life of the power supply is tied to the decay time (or half-life) of the radioisotope. Radioisotope Power Systems (RPSs) are used in applications where long term electrical or thermal power cannot be provided by electrical infrastructure, chemical, solar, storage, or other means.

One type of RPS uses the thermal energy of decay to provide high temperatures required for conversion to electricity either through the use of thermocouples or through a thermodynamic cycle; these are called Radioisotope Thermo-electric Generators (RTGs). Another type of RPS uses the thermal energy for direct heating of electronics and other components, called Radioisotope Heater Units (RHUs). A common use of RTGs, since 1969, is the powering of space missions such as Mars rovers or deep space probes, where the mission duration may require a power source to provide energy for 20 years or more. The Voyager spacecraft have been operating since 1977, powered by RTGs.

“In the summer of 1977, Voyager 1 and 2 left Earth and began their grand tour of the outer planets. Both spacecraft use two RTGs supplied by DOE to generate electricity. Both spacecraft remain operational and are sending back useful scientific data after over 35 years of operation. The RTGs are expected to continue producing enough power for spacecraft operations through 2025, 47 years after launch.”

In the past and currently, NASA has relied on thermal energy from the decay of ²³⁸Pu to provide RPS energy, but ²³⁸Pu is short in supply, is costly to produce, and has a low production rate. The RPS used by the current Curiosity rover on Mars, called a Multi-Mission Radioisotope Thermoelectric Generator (MMRTG), uses approximately 3,300 grams of ²³⁸Pu. An assembled MMRTG is shown in FIG. 1. The production of ²³⁸Pu is done in a reactor, where samples of ²³⁷Np are converted to ²³⁸Np through neutron capture and subsequently decay to ²³⁸Pu by β-decay. “The current production capacity at Oak Ridge National Laboratory is reported to be up to 400 grams of Pu-238 each year, moving closer to NASA's goal of 1.5 kilograms per year by 2025.” At the current production rate, it will take 8.25 years to produce enough ²³⁸Pu for a single 3,300 gram MMRTG.

NASA's Mars 2020 mission will place the Perseverance rover on Mars in 2021 with an MMRTG that was delivered to the Kennedy Space Center in June, 2020 and launched on 30 Jul., 2020. In DOE's announcement of the delivery, Steven Johnson, Director of Space Nuclear Power & Isotope Technologies at Idaho National Laboratory is quoted as saying: “The MMRTG, FIG. 1, is the latest power system provided to NASA by DOE in a long-term relationship to accomplish great things in space exploration.” It is evident that NASA's reliance on RTGs is planned for the long-term. The same announcement indicated that the DOE's next MMRTG is planned to support the Dragonfly rotorcraft lander mission that will explore Saturn's largest moon, Titan, with an anticipated launch date in 2026. A 2017 GAO report indicated that NASA pays approximately $50 million per year for this DOE support of RPSs.

In addition to the availability and cost challenges, ²³⁸Pu's half-life is also not ideal for all planned missions. The planned operational life of the Mars 2020 Perseverance MMRTG is 14 years, though the planned mission duration is “At least one Mars year (about 687 Earth days).” With a ²³⁸Pu half-life of 87.7 years, this means that the MMRTG will only consume 10.5% of the total supplied ²³⁸Pu during the 14-year operational life, or only 1.5% during the nominal planned mission duration.

In addition to providing a heat source for MMRTGs, ²³⁸Pu is also used in Radioisotope Heater Units (RHUs) where the decay heat is used to keep instruments and electronics within an acceptable temperature range. For example, the Mars rovers Spirit and Opportunity, launched in 2003, each used eight RHUs, and “NASA has also identified several new missions potentially requiring RHUs.” Both RTGs and RHUs are based on the same configuration of ²³⁸Pu, called a General Purpose Heat Source (GPHS) that provides adequate protection against the spread of radioactive contamination in the event of a launch accident. A prior-art GPHS includes a stacked assembly 200 of multiple GPHS modules 202, each having an aeroshell frame. The thermal energy of each GPHS module comes from two fuel pellets 204 (FIGS. 1,2) containing PuO₂, clad in iridium metal. A representative stack of four GPHS modules 202 is shown in FIG. 2, with each GPHS module 202 containing two thermal units 204. An MMRTG, such as in FIG. 1, however, may include eight GPHS modules 202.

The illustrated thermal units 204 each include two fuel pellets 206, with a floating membrane 210 therebetween, enclosed within a cylindrical graphite impact shell (GIS) 212 by a cap 214. Each thermal unit 204 is inserted into a respective cylindrical sleeve 216 of carbon bonded carbon fiber (CBCF), between CBCF disks 220, and loaded into a GPHS module 202, and enclosed therein by an aeroshell cap 222 secured by a lock screw 224. The stack is secured together by lock fasteners 226. The length L, width W, and height H, can vary among embodiments. In one non-limiting example: L=9.957 cm; W=9.317 cm; and H=5.817 cm.

Pu-238 undergoes radioactive decay by emitting an alpha particle to become ²³⁴U. This uranium daughter product has a half-life of 245,500 years, so even though this uranium isotope will build up as the plutonium decays, it does not have a decay rate high enough to contribute to the energy production over the life of an RPS. The specific energy production rate of pure ²³⁸Pu (Watts per initial gram of material) is shown in FIG. 3 over a period of 20 years, with an initial value of 0.56 W/g and a final value of 0.48 W/g.

In 2009, the National Research Council reported in a study on radioisotope power systems that Plutonium-238 is the only isotope suitable as an RPS fuel for long-duration missions because of its half-life, emissions, power density, specific power, fuel form, availability, and cost.

While this may be true for single isotope power sources, there is another viable approach. U.S. Pat. No. 3,632,520A, filed in 1968 by the AEC, proposed a mixture of isotopes; specifically, ²³⁸Pu (t_{1/2}=87.7 years) and ²⁴¹Pu (t_{1/2}=14.3 years), to provide a radioisotope fuel with a relatively constant power level over an operational period of several decades.

When a radioactive daughter product has a significantly shorter half-life than the precursor parent, the activity, or decay rate, of the daughter product will approach the activity of the parent in a condition called secular equilibrium. An explanation of this condition is represented by the following analogy. If a chain of radioactive decay products is represented by a vertical stack of cups, where each cup represents a different product in the chain, and each cup has a hole in the bottom leading to the next cup, with a hole size proportional to the decay constant (inversely proportional to the half-life), then the time history of each isotope in the chain may be represented by the flow of water through the stack of cups. In this example of secular equilibrium, the first cup has a very small hole (long half-life) and all the subsequent cups have significantly larger holes. Starting with a purified sample of the parent isotope, represented by a full top cup, intuition suggests that the flow rate (or activity) from the lower cups will all approach the flow rate from the top cup. This equilibrium is established in approximately five to seven half-lives of the daughter product. In some cases, a long chain of rapidly decaying daughter products can all be in secular equilibrium with the primary precursor isotope.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

In various embodiments, ²¹⁰Pb and ²²⁷Ac are used in thermal energy production as precursor isotopes, which have been isolated and are allowed to age to the point of secular equilibrium with their progeny, referring to the decay product isotopes in the radioactive decay chain of each. Both ²¹⁰Pb and ²²⁷Ac are in the radioactive decay chains of naturally occurring uranium isotopes, and are each subject to their own natural radioactive decay. While not particularly energetic through their own decay, they (1) are separable from their parent isotopes or may be created in a reactor, (2) have half-lives of around 22 years, and (3) are precursors (natural radioactive decay parents) to subsequent rapid and energetic decay processes. These two isotopes can offer significant advantages as RPS fuel compared to the currently used ²³⁸Pu.

Specifically, ²¹⁰Pb and ²²⁷Ac based sources provide a higher specific energy rate (Watts/gram) than ²³⁸Pu, with the possibility of significant cost savings, a higher level of RPS mission support, and adequate service life for most RPS requirements. It has also been shown that the precursor-based fuel can be configured as a drop-in replacement for currently used heat sources in RPSs. Further, the configuration of the fuel in such precursor-based TRISO particles will provide the necessary thermal and mechanical safety and performance.

In at least one embodiment, a heat-emanating device includes a fuel element containing a radioactive precursor isotope having a progeny of decay products, the radioactive precursor isotope being in secular equilibrium in the fuel element with its progeny of decay products.

In at least one example, at least a first shell layer encases the fuel element.

The first shell layer may include a porous carbon buffer layer. The heat-emanating device may further include: a second shell layer adjacently encasing the first shell layer, the second shell layer comprising pyrolytic carbon; and a third shell layer adjacently encasing the second shell layer, the third shell layer comprising silicon carbide.

The heat-emanating device may further include a fourth shell layer adjacently encasing the fourth shell layer, the fourth shell layer comprising pyrolytic carbon.

The heat-emanating device can be configured as a TRISO fuel particle.

The fuel element may include a spheroidal fuel kernel.

The fuel element may have a mass of less than a milligram.

The radioactive precursor isotope may be ²¹⁰Pb.

The radioactive precursor isotope may be ²²⁷Ac.

The radioactive precursor isotope may be in secular equilibrium in the fuel element with its progeny of decay products by way of aging the heat emanating device.

In at least one embodiment, a heat source includes at least one precursor-based heat-emanating pellet, the pellet having multiple fuel elements. Each fuel element contains a radioactive precursor isotope having a progeny of decay products, the radioactive precursor isotope being in secular equilibrium in the fuel element with its progeny of decay products.

The pellet may further include an overcoat and a binder.

The overcoat may include graphite.

The binder may include resin.

The pellet may be configured as a circular cylinder.

In at least one embodiment, method of providing thermal energy includes: using, as a thermal energy source, ²¹⁰Pb or ²²⁷Ac as a precursor isotope which has been isolated and allowed to age to the point of secular equilibrium with the progeny thereof, the thermal energy source providing a higher specific energy rate (Watts/gram) than ²³⁸Pu.

The thermal energy source may be configured as a TRISO particle.

The thermal energy source may be used to power an MMRTG.

The thermal energy source may be used on an unmanned spacecraft.

The thermal energy source may include a layered particle having a central fuel kernel encased by at least one shell layer, with the fuel kernel containing at least a portion of the ²¹⁰Pb or ²²⁷Ac used as a precursor isotope.

The above summary is to be understood as cumulative and inclusive. The above described embodiments and features are combined in various combinations in whole or in part in one or more other embodiments.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is a prior-art mage of the Perseverance rover MMRTG.

FIG. 2A is an exploded view of prior-art GPHS modules.

FIG. 2B is a prior-art image of a fuel pellet as used in the GPHS modules of FIG. 1.

FIG. 3 is a prior-art plot Specific Power Production of ²³⁸Pu.

FIG. 4 is a decay-scheme illustration of the ²¹⁰Pb decay chain.

FIG. 5 is a decay-scheme illustration of the ²²⁷Ac decay chain.

FIG. 6 graphs specific Power Production of ²¹⁰Pb and ²³⁸Pu per initial gram of material.

FIG. 7 graphs specific power production of ²²⁷Ac and ²³⁸Pu per initial gram of material.

FIG. 8 is a neutron cross section plot of ²²⁶Ra data.

FIG. 9 shows results of an MCNP simulation.

FIG. 10 plots gamma emission (>500 keV) from a ²³⁸Pu RPS source over the first five years after source preparation.

FIG. 11 plots gamma emission (>500 keV) from a ²¹⁰Pb RPS source over the first two years after source preparation, per Watt produced at secular equilibrium.

FIG. 12 plots gamma emission (>500 keV) from a ²²⁷Ac RPS source over the first ½ year after source preparation, per Watt produced at secular equilibrium.

FIG. 13 is a cut-away view of a prior-art TRISO fuel particle.

FIG. 14 is a cross-sectioned view of a precursor-based layered particle according to at least one embodiment of inventive aspects of these descriptions.

FIG. 15 is a pellet, according to at least one embodiment of inventive aspects of these descriptions, containing a plurality of precursor-based layered particles.

FIG. 16 shows a stacked assembly of precursor-based modules, according to at least one embodiment of inventive aspects of these descriptions, each containing multiple pellets, each of which containing a plurality of precursor-based layered particles.

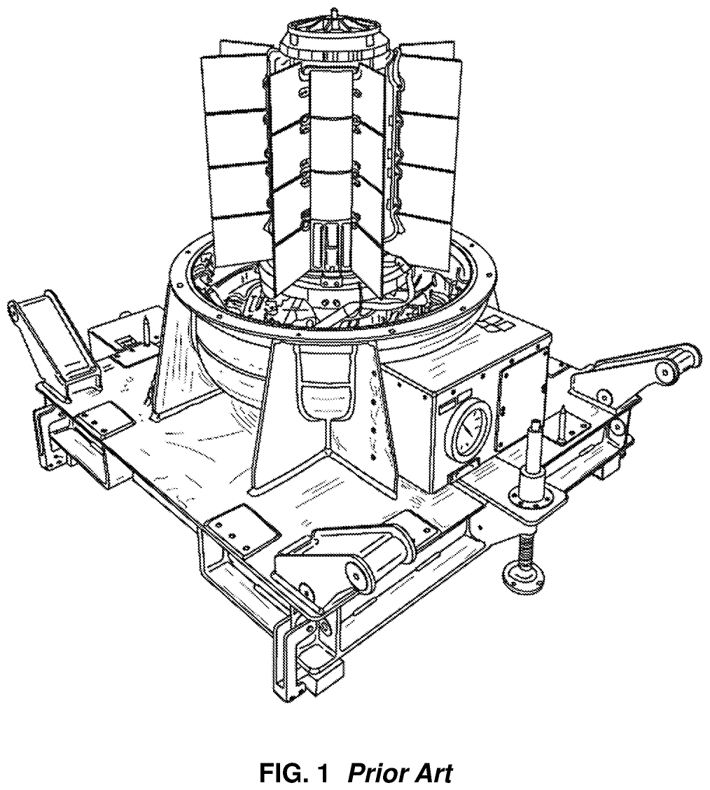

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

These descriptions relate to radioisotope fuel. While the commonly used prior-art GPHS configuration contains fuel pellets of PuO₂ clad in iridium, the PuO₂ fuel could be replaced by another suitable radioactive isotope in the GPHS module. The subject of these descriptions is the identification of other suitable isotope combinations for use in RPSs.

A chain of rapidly decaying daughter products can all be in secular equilibrium with the primary precursor isotope. The separation of these precursors from uranium and uranium decay products or the creation of these precursors and the use of precursor isotopes in RPSs provides a novel; and non-obvious alternative to ²³⁸Pu based power supplies.

Radioactive decay produces energetic particles and photons that may be captured for conversion to useful energy forms. Radioisotope power sources are used in space missions and other remote power applications. For space applications, ²³⁸Pu is used as a power and heat source and a study completed by the National Research Council in 2009 indicated that no other known isotope could meet the radioisotope power needs of space exploration. Plutonium-238 can be produced in a reactor, but at great cost. While ²³⁸Pu may be the only single isotope suitable for long duration power needs, this invention proposes that two naturally occurring precursor isotopes, ²²⁷Ac and ²¹⁰Pb, exceed the performance of ²³⁸Pu in some respects after their decay progeny achieve secular equilibrium. As these isotopes are naturally occurring or may be produced in a reactor using available materials, their use may result in significant cost savings. These isotopes can be configured in a TRISO-based fuel configuration as a drop-in replacement for currently used RPS heat sources, with the TRISO particles providing a high level of safety as well as thermal and mechanical performance.

According to at least one embodiment, ²¹⁰Pb and ²²⁷Ac samples are either separated or produced and purified, and each of the respective decay chains come to secular equilibrium with the parent over a period of time, at which point the activity, or decay rate, of each member of the decay chain is equal to that of the precursor parent. While neither of these isotopes are used as a power source individually because of low energy emissions in radioactive decay, the process of sample purification, followed by a wait time for the establishment of secular equilibrium will yield a heat source with higher specific power density (W/g) than the currently used ²³⁸Pu.

These descriptions detail the use of radioisotopes, specifically ²¹⁰Pb and ²²⁷Ac, in RPSs and suggests non-limiting examples of processes by which they are either created or separated from their source materials including uranium, uranium ore or tailings, radium, and radon materials. Patents JPH1170323A and U.S. Pat. 3,432,386A provide examples of separation processes. In addition, these descriptions suggest possible material configurations for the isotopic material. See patents U.S. Pat. No. 3,790,440A and U.S. Pat. No. 3,632,520A, for examples of material configurations.

These descriptions detail the use of two additional heat sources in RPSs: ²¹⁰Pb and ²²⁷Ac parent isotopes, each (eventually) in secular equilibrium with their radioactive progeny. These both have energetic and short-lived progeny that will come to secular equilibrium with the precursor parent within two years and six months, respectively, providing a long duration and energetic power source. Both precursors have half-lives around 22 years—an ideal period for many space missions or other anticipated uses of RPSs. The decay chains associated with each of these two precursors do exhibit gamma emissions (at a higher level than ²³⁸Pu) but no inherent neutron emission (whereas ²³⁸Pu does exhibit inherent neutron emission through spontaneous fission).

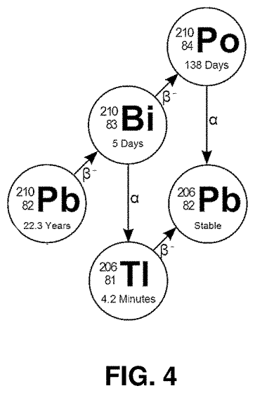

The ²¹⁰Pb decay chain in FIG. 4 shows the (primary) path from ²¹⁰Pb to ²¹⁰Bi to ²¹⁰Po to stable ²⁰⁶Pb. Half lives indicated show that secular equilibrium is expected within two years of sample purification. Note that the path from ²¹⁰Bi to ²⁰⁶Tl is extremely rare, but all possible paths were included in the analysis.

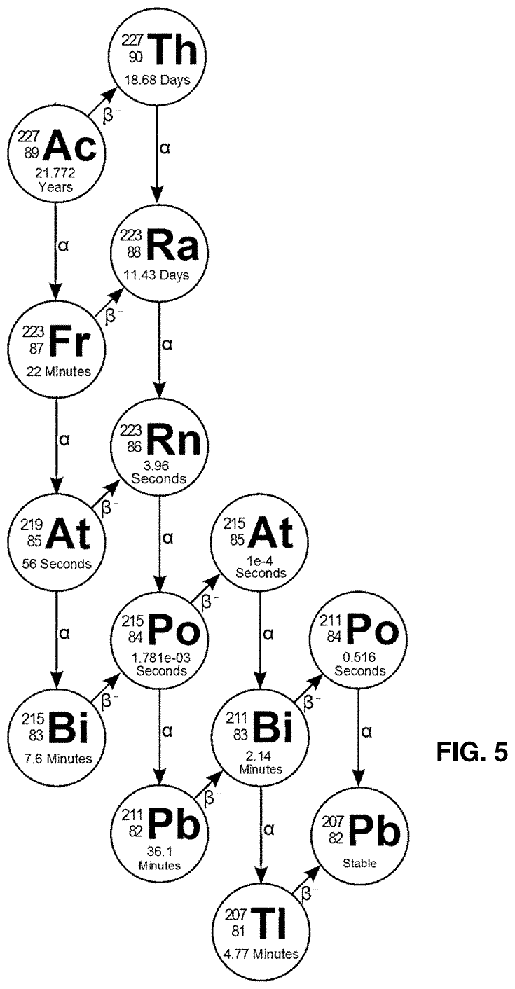

The ²²⁷Ac decay chain in FIG. 5 shows the emission of five energetic alpha particles on the way to stable ²⁰⁷Pb. Shown half-lives indicate that secular equilibrium will be achieved in less than half a year.

Lead-210 is an isotope near the end of the ²³⁸U decay chain with a half-life of 22.7 years. While the decay energy from ²¹⁰Pb itself is nearly negligible (˜10.5 keV per decay), the energy from its progeny is not. The decay path from ²¹⁰Pb is almost entirely a β-decay to ²¹⁰Bi (t_{1/2}=5.01 days), a second β-decay from bismuth to ²¹⁰Po (138.4 days), followed by a third alpha decay from polonium to stable ²⁰⁶Pb. In such decay chains, the time related activity of all the isotopes may be calculated using the well-known Bateman Equations.

In the previously mentioned study by the National Research Council, ²¹⁰Pb was dismissed because it is simply a low energy beta emitter and ²¹⁰Po, the subsequent higher energy alpha emitter, was not included for consideration as an alternative because of its short half-life. If ²¹⁰Pb is isolated, the ²¹⁰Po granddaughter will be in secular equilibrium with the ²¹⁰Pb in approximately two years (or less than 1/10th a half-life of the parent).

Lead-210 is present in uranium ore, although its separation from more plentiful stable lead isotopes (Pb-204, 206, 207, 208) may be challenging. Alternatively, it may be found in older radium samples with a concentration of up to 10 grams per kg in those cases where the radon gas has not escaped the sample. Additionally, if radon gas is collected from uranium ore, tailings, depleted uranium, etc., the radon gas resulting from ²³⁸U decay (²²²Rn; t_{1/2}=3.82 days) will decay to ²¹⁰Pb within days, while the radon gas resulting from ²³⁵U decay (²¹⁹Rn; t_{1/2}=3.96 sec with quick subsequent decay to stable ²⁰⁷Pb) may not make it to the point of gas collection, allowing the collection of relatively pure ²¹⁰Pb through radon collection. As an example, the mining tailings associated with 1000 tons of uranium metal will produce ²²²Rn at a rate of 0.4 milligrams/day. In addition, Japanese patent JPH1170323A suggests that ²¹⁰Pb may be isolated by atomic vapor laser isotope separation. While these descriptions do not detail directly the separation of ²¹⁰Pb, these examples of material sourcing are given to support the viability of this isotope as a power source.

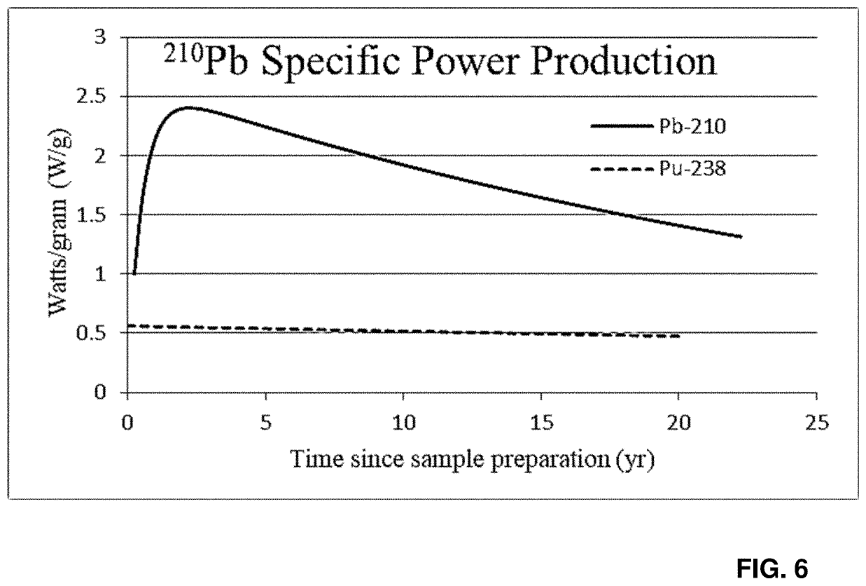

One of the criteria identified by the NRC study was “emissions.” An ideal radioisotope power source will only emit short range particles (alpha and beta) and low energy photons so that all the decay energy is captured within the power source itself and surrounding instruments and materials are not irradiated. The ²¹⁰Pb precursor power source meets this criterion in that the gamma emissions above 500 keV represent only 0.00015% of the total decay energy when the source is in secular equilibrium. Still, this low contribution from gamma rays is significantly higher than the gamma emission from ²³⁸Pu, as discussed later. In addition to the energy from the ²¹⁰Pb and ²¹⁰Po alpha particle, the chain does include one beta particle of note; an average of ˜389 keV from the ²¹⁰Bi, bringing the total recoverable energy deposition to 5,704 keV/decay after approximately two years when the daughter products have achieved secular equilibrium. As a point of comparison, the recoverable energy from ²³⁸Pu is approximately 5488 keV/decay. In addition, with a half-life approximately ¼th that of ²³⁸Pu, the ²¹⁰Pb will have a decay rate approximately four times that of the ²³⁸Pu with the same number of atoms, so the specific power density value for ²¹⁰Pb will be approximately four times that of ²³⁸Pu. This implies that for the same RPS power for a 10 to 20-year mission, significantly less ²¹⁰Pb fuel mass is required compared to ²³⁸Pu. The specific energy production (Watts of thermal power per initial gram of material) of a ²¹⁰Pb precursor source is shown in FIG. 6 over a period of 20 years.

The specific power production for a ²¹⁰Pb source reaches a maximum of 2.42 W/g at 2.25 years, decreasing to 1.41 W/g at 20 years. (Note that all specific power values are given per initial gram of fuel material.) For comparison, the initial (and maximum) specific power production of a pure ²³⁸Pu source is 0.557 W/g and this value decreases to 0.476 W/g at 20 years. For RPSs at the 20-year point with matching thermal power output, a system based on plutonium would need to have started with three times the amount of fuel compared to a lead based RPS.

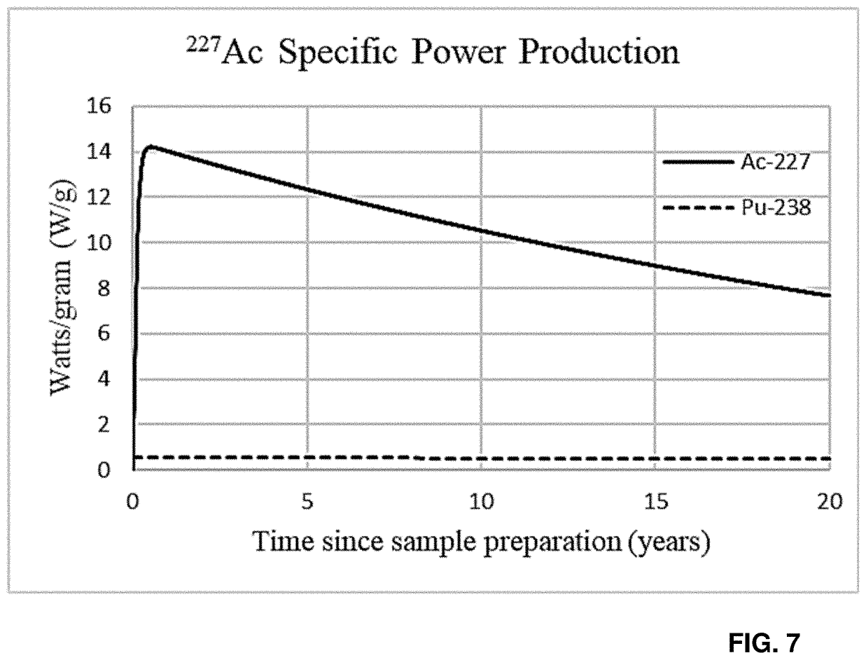

Actinium-227 is the great-granddaughter of ²³⁵U, and exists in naturally occurring protactinium with a concentration of approximately 0.65 grams per kg protactinium (naturally occurring protactinium is ˜100% ²³¹Pa). Between ²²⁷Ac and stable ²⁰⁷Pb, there is an eight-step decay process through seven additional isotopes, including the emission of five α particles and three β particles. While ²²⁷Ac has a 21.77 year half-life, the longest lived in the subsequent chain is the immediate daughter product of ²²⁷Ac decay: ²²⁷Th, with a half-life of 18.7 days. The application of the previously mentioned Bateman equations shows a condition of secular equilibrium being achieved after approximately 6 months from the time of ²²⁷Ac separation, with a maximum specific power density of 14.25 W/g at 6.1 months. Note that this value is close to five times the maximum power density of a ²¹⁰Pb source (primarily due to the emission of five alpha particles in the decay chain), and 25 times the maximum power density of a ²³⁸Pu source. This implies that significantly less source material is required for the same thermal output. The specific power production from an ²²⁷Ac based source is shown in FIG. 7 over a period of 20 years. As seen in FIG. 7, there is a relatively rapid rise to secular equilibrium with ²²⁷Ac compared to the ²¹⁰Pb due to actinium having shorter lived daughter products. Note that at an age of 20 years, the ²²⁷Ac source material still has a specific power density of 7.7 W/g, 16 times that of ²³⁸Pu at the 20-year point. In other words, an ²²⁷Ac RPS power source comprising only 1/16th the fuel mass will exceed the power output of the ²³⁸Pu device over a period from approximately 6 months to 20 years.

Regarding the criteria identified by the NRC study related to emissions, the ideal radioisotope power source will only emit short range particles (alpha and beta) and low energy photons so that all the decay energy is captured within the power source itself and surrounding instruments and materials are not irradiated. The ²²⁷Ac precursor power source has significantly higher gamma emissions that either ²³⁸Pu or ²¹⁰Pb, yet the gamma emissions above 500 keV represent only 0.13% of the total decay energy when the source is in secular equilibrium. More information is provided on ²²⁷Ac gamma emissions later.

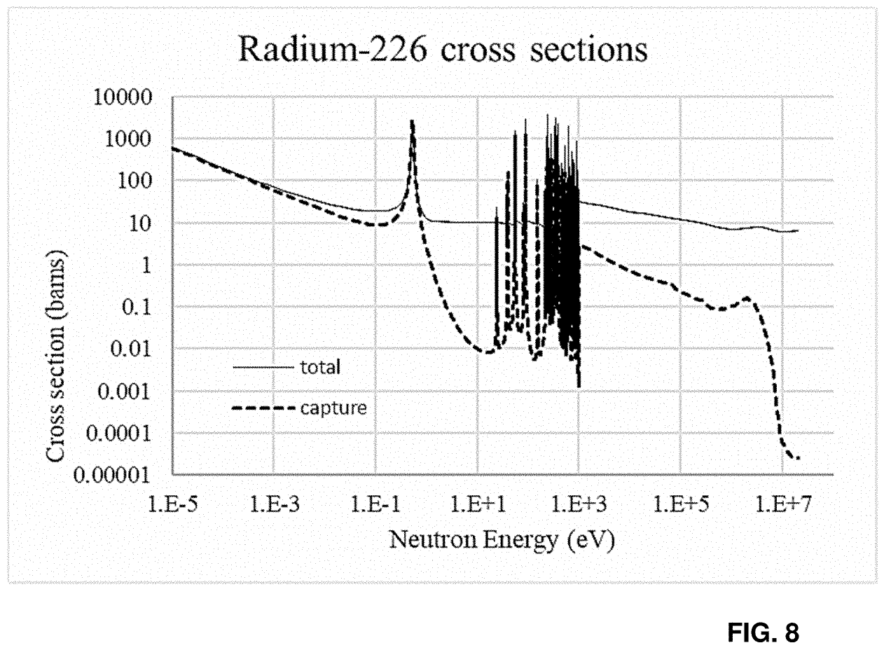

Though naturally occurring, actinium is not plentiful. It may be created in a reactor through the neutron irradiation of ²²⁶Ra. FIG. 8 shows the neutron capture and total neutron cross sections for ²²⁶Ra, indicating that (1) capture is the most likely interaction at neutron energies below 1 eV, and (2) the value of the capture cross section at 0.0253 eV is acceptably high at 12.8 barns. The product of neutron capture, ²²⁷Ra, decays by beta emission to ²²⁷Ac with a 42-minute half-life. This suggests that the creation of ²²⁷Ac in a thermal reactor is feasible. It should be noted, however, that the ²²⁷Ac itself has a thermal (0.0253 eV) capture cross section of 800 barns, implying that the yield will be asymptotic.

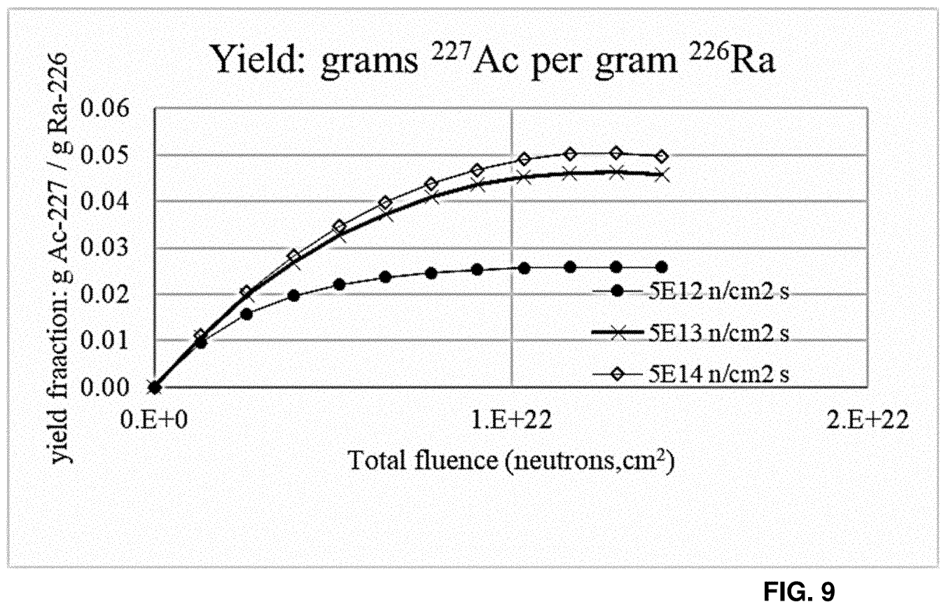

Results of an MCNP simulation are shown in FIG. 9, where the maximum yield approaches 0.05 grams ²²⁷Ac per gram ²²⁶Ra, depending on the fluence rate. Results are plotted for total fluence. For example, for the case where the ²²⁶Ra seed material is exposed to a flux of 5×10¹⁴ n/cm²·s, the total fluence of 1×10²² n/cm² is achieved after an exposure time of 230 days. Viability of the sourcing of the ²²⁷Ac is not required for this invention, but details are given here to show feasibility of the acquisition of kg quantities of this source, based on the availability of ²²⁶Ra.

FIG. 9 shows the results of MCNP simulation of the conversion of ²²⁶Ra to ²²⁷Ac in a thermal reactor, with three different average flux levels, plotted as a function of total fluence.

A report prepared by NASA's Center for Space Nuclear Research indicates that the yield of ²³⁸Pu from ²³⁷Np is less than 0.013 grams ²³⁸Pu per gram ²³⁷Np, or approximately ¼^{th} the possible yield of ²²⁷Ac from ²²⁶Ra.

Comparison of Undesirable Source Emissions: Another point to be addressed is that of undesirable emissions. Alpha and beta particles have a short range, so all their energy is deposited in the RPS device. Low energy gammas and X-rays will also likely be attenuated in the RPS. Higher energy photons and neutrons may escape the RPS and present a hazard to personnel or instrumentation. Instruments used in space exploration rely on electronics that are hardened to enable their use in the higher radiation environments of space, but the RPS should not significantly contribute to the radiation environment. For this comparison, we normalize the photon and neutron emissions to an amount of material that will provide one Watt of thermal output after the ²¹⁰Pb and ²²⁷Ac precursor sources are in secular equilibrium with their progeny.

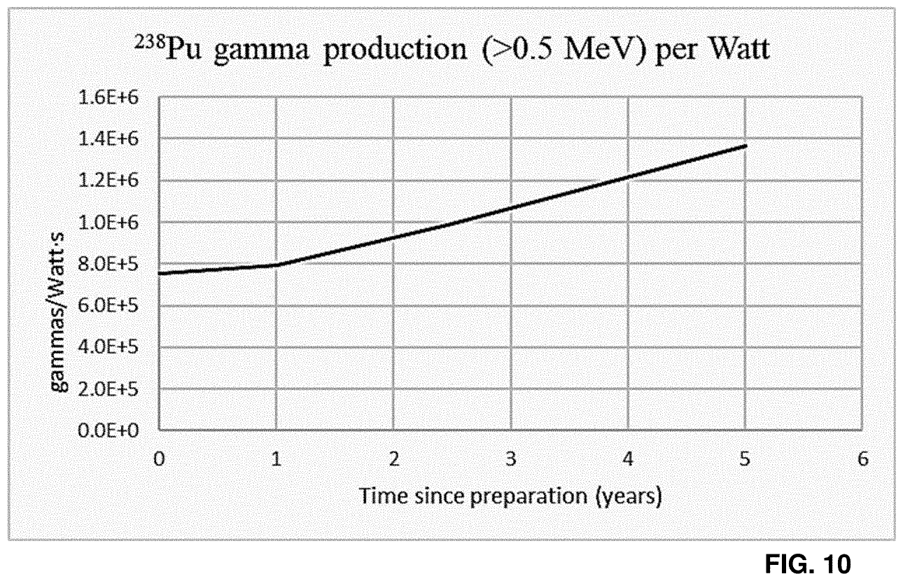

The gamma and neutron emissions from ²³⁸Pu RPS sources were reported in a study conducted at Savannah River National Laboratory in 1965. The gamma emissions indicated in this study are shown in FIG. 10, which includes plots of gamma emission (>500 keV) from a ²³⁸Pu RPS source over the first five years after source preparation.

The study also indicated a neutron emission rate from the ²³⁸Pu RPS source of 2.1×10⁴ neutrons/gram·second, resulting from both (α,n) reactions with the oxygen present in the fuel compounds and the spontaneous fission of ²³⁸Pu. When considering a full MMRTG comprising 3300 grams of fuel, this neutron production is approximately 7×10⁷ n/s, an emission rate that will complicate handling of the devices.

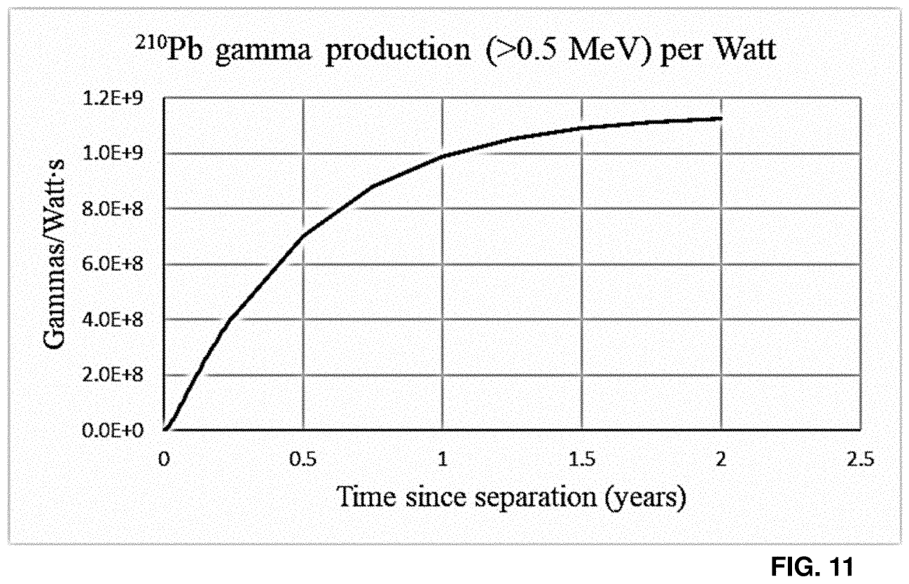

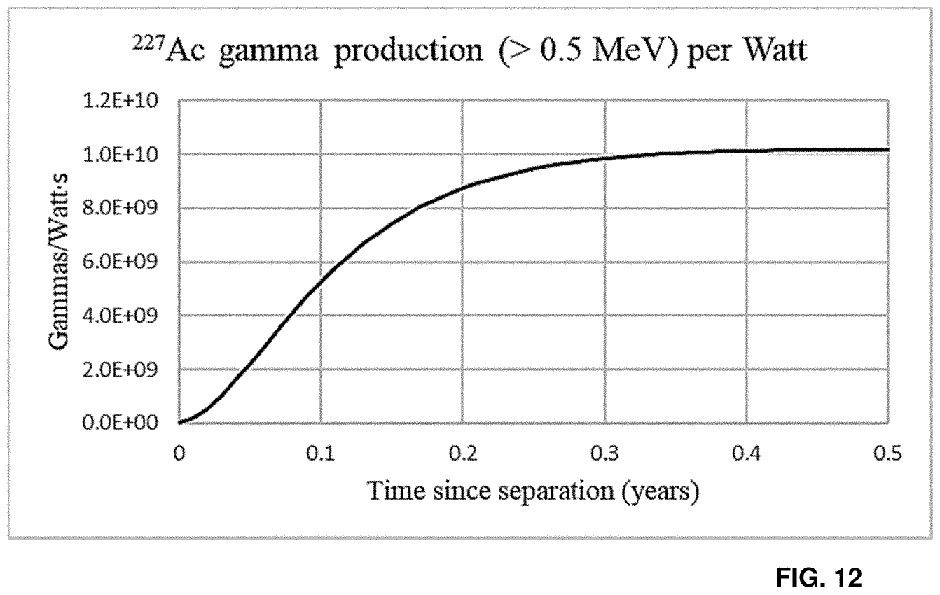

For the inventive ²¹⁰Pb and ²²⁷Ac sources according to these descriptions, the high energy (>500 keV) gamma emissions come almost exclusively from the daughter products, so these gamma emissions are initially very low, then build with the accumulation and decay of daughter products, reaching a maximum at the point of secular equilibrium, and then subsequently decaying with the half life of the parent isotope. The buildup of high energy gamma emissions from the ²¹⁰Pb source is shown in FIG. 11 and the buildup from the ²²⁷Ac source is shown in FIG. 12. Note that both the precursor sources have significantly higher gamma output than ²³⁸Pu, and that the gamma output increases over a period of several months after source isotope separation, meaning that the processing of the source material will become more difficult as it ages. Neither the ²¹⁰Pb nor ²²⁷Ac sources have inherent neutron emissions, unlike the ²³⁸Pu source, but neutron emissions are possible from these sources if the source material is combined with low atomic number elements (oxygen, for example), where (α,n) reactions can result.

According to inventive aspects of these descriptions, the precursor isotopes ²¹⁰Pb and ²²⁷Ac, when isolated and are allowed to age to the point of secular equilibrium with their progeny, can offer significant advantages as RPS fuel compared to the currently used ²³⁸Pu. Specifically, ²¹⁰Pb and ²²⁷Ac based sources provide a higher specific energy rate (Watts/gram) than ²³⁸Pu, with the possibility of significant cost savings, a higher level of RPS mission support, and adequate service life for most RPS requirements.

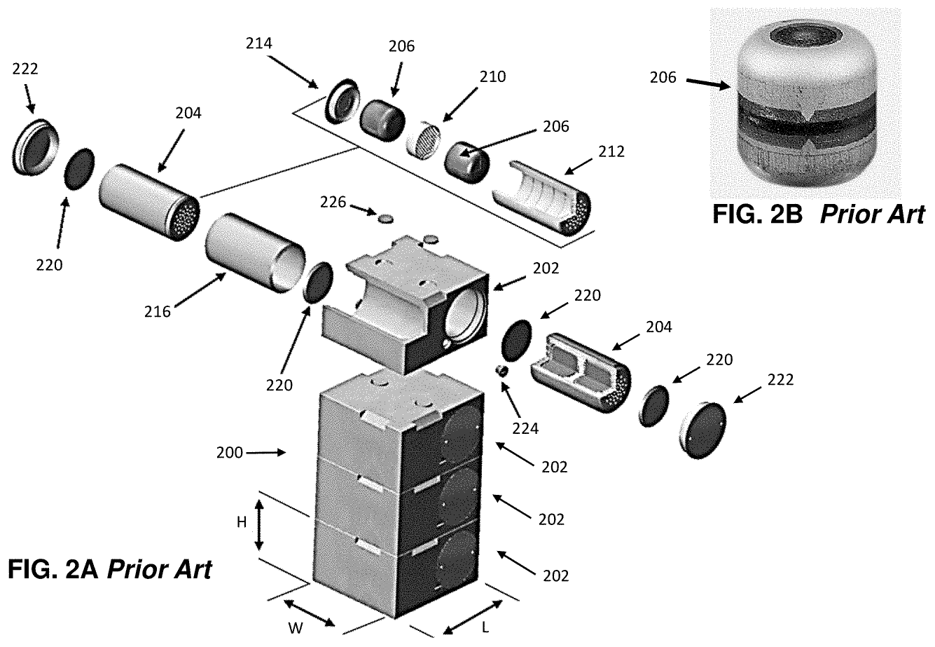

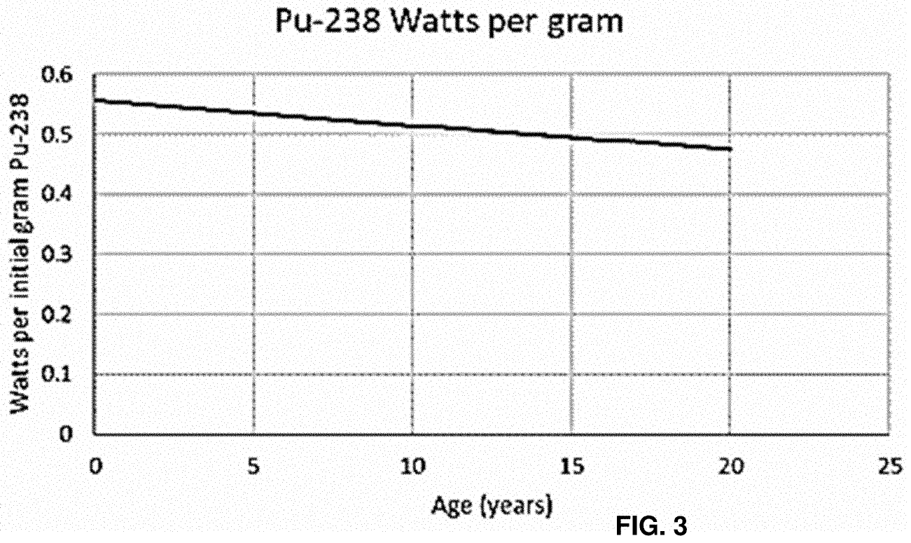

Precursor based RPS configuration—As any useful RPS will contain a significant amount of radioactive material, the safety of the source packaging is of concern. This concern is evident in the configuration of an MMRTG's General Purpose Heat Source modules 202, seen in FIG. 2A, where numerous levels of containment are indicated.

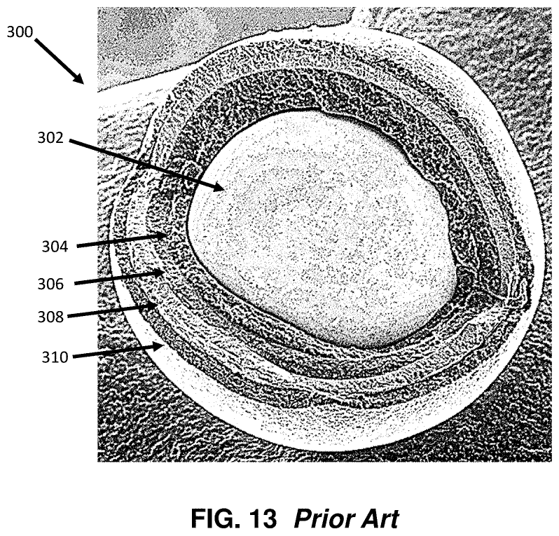

The nuclear industry is currently pursuing the development of advanced reactors that will use a new fuel configuration: TRISO fuel particles. This fuel concept, first developed in the 1950's and currently undergoing significant development and testing, has been called, by the U.S. Department of Energy, the most robust fuel configuration on Earth. The name stands for TRi-structural ISOtropic, and this configuration consists of a multi-layer coated particle, approximately 0.86 mm in diameter, pictured in FIG. 13.

As seen in FIG. 13, the center portion of the TRISO particle 300 contains a fuel kernel 302 with a diameter of 0.425 mm. Outside the kernel 302 is a porous carbon buffer layer 304, an inner layer of pyrolytic carbon 306, a layer of silicon carbide 308 (seen as the lighter colored layer), and an outer layer of pyrolytic carbon 310. The fuel kernel can comprise different fuel materials, including oxides, carbides, and oxide/carbide mixtures of fissile and fertile fuel materials.

For precursor-based fuel according to these descriptions, a novel approach is used. Compounds of lead and actinium would also be possible as kernel “fuel” compounds, including lead and actinium oxides. Two of the noteworthy properties of TRISO particles are their ability to provide containment of the fuel material and their ability to withstand extremely high temperature environments. The U.S. Department of Energy indicates that TRISO particles cannot melt in a reactor and can withstand extreme temperatures that are well beyond the threshold of current nuclear fuels. Such strength and high temperature performance are ideally suited to the containment of radioactive source material in an RPS.

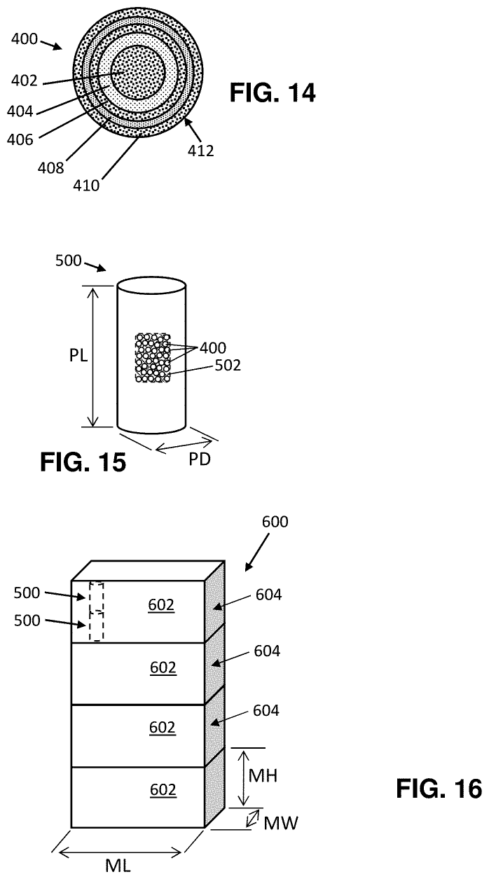

According to some inventive aspects of these descriptions, heat emanating devices configured as layered particles including radioactive precursor isotope sources, isotopes such as ²¹⁰Pb or ²²⁷Ac, are incorporated into pellets for RPS application. A precursor-based or powered layered particle 400 is shown FIG. 14 as a TRISO particle. In the illustrated embodiment, the layered particle 400 is generally spherical or spheroidal, and contains a fuel element configured in the illustrated embodiment as a central fuel kernel 402. The kernel 402 is adjacently encased by a porous carbon buffer layer, which is referenced as a spheroidal first shell layer 404. The first shell layer 404 is adjacently encased by an inner layer of pyrolytic carbon, which is referenced as a spheroidal second shell layer 406. The second shell layer 406 is adjacently encased by a layer of silicon carbide, which is referenced as a spheroidal third shell layer 408. The third shell layer 408 is adjacently encased by a layer of pyrolytic carbon, which is referenced as a spheroidal fourth shell layer 410. The outer surface of the fourth shell layer 410 defines the spheroidal outer surface 412 of the layered particle 400 in the illustrated embodiment.

Mixing the fuel with graphite (at the center of a TRISO particle) may be advantageous for accommodation of the ⁴He buildup, particularly with the ²²⁷Ac source with all the alpha emissions.

FIG. 15 is a perspective view of a precursor-based pellet 500, according to at least one embodiment of inventive aspects of these descriptions, containing a plurality of precursor-based layered particles 400. In the illustrated embodiment, a plurality of approximately 4,100 inventive precursor-based particles 400 are provided with an overcoat 502 of graphite and binder resin, and are then compacted into pellet 500 formed as a circular cylinder, having a length PL and a diameter PD. A portion of the pellet is shown in an enlarged view, as represented in dashed line in FIG. 15, to permit view of the particles 400 and overcoat material. In a non-limiting example, PL is approximately 2.5 cm, and PD is approximately 1.2 cm, as indicated in FIG. 15. Note that this number of TRISO particles within a pellet with these dimensions represents a volume fraction of 47%, with the remainder comprising the overcoat material.

As indicated previously, a modern prior-art MMRTG includes approximately 3,300 grams of ²³⁸Pu, producing approximately 1850 Wₜₕ (Watts thermal) initially, and 1570 Wₜₕ after 20 years. Matching this thermal power output at the 20-year point using precursor-based fuels according to inventive aspects described herein will require initial totals of 1,114 grams of ²¹⁰Pb or 204 grams of ²²⁷Ac. Note that by matching the power level at the 20-year point, precursor-based RTGs will provide significantly more thermal power, compared to the ²³⁸Pu source, between the point of secular equilibrium and the 20-year point, so significantly less precursor source material may be appropriate for shorter missions. Secular equilibrium may be reached by aging the source. The time period of aging may be accommodated in a space mission through time of space travel. Thus a device doesn't need to be aged necessarily before launch. It can be installed in a mission craft in a non-equilibrium condition and achieve equilibrium on its way. There may be power requirements during spaceflight, but the in-transit power requirements may lower than those during active portions of the mission.

Because the precursor-based ²¹⁰Pb source will require greater material volume (or more TRISO particles) than a system fueled with ²²⁷Ac, the design case is only presented here for the limiting ²¹⁰Pb source. A precursor-based ²²⁷Ac RPS heat source would be similar in many respects except with regard to the pellets containing fewer TRISO particles and more overcoat and binder material. Each TRISO particle contains a fuel kernel volume of 0.0402 mm³. Lead oxide (PbO) has a density of 9.53 g/cm³, and a lead density of 8.85 g/cm³, so each TRISO particle will contain 0.356×10⁻³ grams of lead source material. Each pellet 500 of the above non-limiting example (PL is approximately 2.5 cm, and PD is approximately 1.2 cm) containing 4100 particles, will contain 1.46 grams of lead source material.

A stacked assembly 600 of multiple precursor-based modules 602 according to inventive aspects of these descriptions is shown in FIG. 16. The precursor-based modules 602, singly or in combination as in the assembly 600, can be utilized, for example, as drop-in replacements of prior-art GPHS systems, with reference for example to the prior-art stacked assembly 200 of multiple GPHS modules 202 (FIG. 2A).

The stacked assembly 600 includes multiple precursor-based modules 602, each having an aeroshell frame 604. The thermal energy of each module 602 (FIG. 16) comes from multiple precursor-based pellets 500. In FIG. 16, four modules 602 are expressly illustrated in the assembly 600. However, an assembly 600 of modules 602 can have any number of modules 602. The pellets 500 are shown in dashed-line in a representative one of the modules 602 in FIG. 16 to represent their interior placement. Each other module 602 can also contain pellets 500, where the number and arrangement of the pellets 500 within a module 602 can vary among embodiments. The illustrated modules 602 are rectangularly shaped, each in a box-like configuration, having a length ML, a width MW, and a height MH, each of which can vary among embodiments.

In a non-limiting embodiment, the pellets 500 are arranged in the modules 602 as a 7×7 array, two high, with graphite and binder material in the interstitial spaces and a structural material on the outside surface 604. In a non-limiting example thereof, each module 602 has a length ML of approximately 9.7 cm, a width MW of approximately 9.3 cm, and a height MH of approximately 5.3 cm.

As indicated previously, the prior art MMRTG design represented in FIG. 2A includes eight GPHS modules 202. Inventive pre-cursor modules 602 configured as replacements, with reference to replacing the modules 202, can have the same dimensions as the modules 202 but configured as represented in FIGS. 14-16 and as described with reference thereto. Each such module 602, in a non-limiting example, contains 98 pellets (two 7×7 stacked arrays), with a total of 143 grams of ²¹⁰Pb in each module 602. A stacked assembly 600 having eight such modules 602 contains a total of 1140 grams of ²¹⁰Pb. Such a replacement assembly 600, intended to the replace a prior-art stacked assembly 200 (FIG. 2A) having eight GPHS modules 202, will provide a thermal power of 2760 Wₜₕ at the point of maximum output (2.25 years) and 1610 Wₜₕ at 20 years, whereas such a prior-art assembly using ²³⁸Pu provides initial and 20-year thermal power levels of 1850 Wₜₕ and 1570 Wₜₕ.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

1. A heat-emanating device comprising:
a fuel element comprising a radioactive precursor isotope having a progeny of decay products, the radioactive precursor isotope being in secular equilibrium in the fuel element with its progeny of decay products.

2. The heat-emanating device of claim 1, further comprising at least a first shell layer encasing the fuel element.

3. The heat-emanating device of claim 2, wherein the first shell layer comprises a porous carbon buffer layer, and wherein the heat-emanating device further comprises:
a second shell layer adjacently encasing the first shell layer, the second shell layer comprising pyrolytic carbon; and
a third shell layer adjacently encasing the second shell layer, the third shell layer comprising silicon carbide.

4. The heat-emanating device of claim 3, further comprising:
a fourth shell layer adjacently encasing the fourth shell layer, the fourth shell layer comprising pyrolytic carbon.

5. The heat-emanating device of claim 4, wherein the heat-emanating device is configured as a TRISO fuel particle.

6. The heat-emanating device of claim 1, wherein the fuel element comprises a spheroidal fuel kernel.

7. The heat-emanating device of claim 1, wherein the fuel element has a mass of less than a milligram.

8. The heat-emanating device of claim 1, wherein the radioactive precursor isotope comprises ²¹⁰Pb.

9. The heat-emanating device of claim 1, wherein the radioactive precursor isotope comprises ²²⁷Ac.

10. The heat-emanating device of claim 1, wherein the radioactive precursor isotope is in secular equilibrium in the fuel element with its progeny of decay products by way of aging the heat emanating device.

11. A heat source comprising:
at least one precursor-based heat-emanating pellet, the pellet comprising:
multiple fuel elements, each said fuel element comprising a radioactive precursor isotope having a progeny of decay products, the radioactive precursor isotope being in secular equilibrium in the fuel element with its progeny of decay products.

12. The heat source of claim 11, wherein the pellet further comprises an overcoat and a binder.

13. The heat source of claim 12, wherein the overcoat comprises graphite.

14. The heat source of claim 12, wherein the binder comprises resin.

15. The heat source of claim 11, wherein the pellet is configured as a circular cylinder.

16. A method of providing thermal energy comprising:
using a thermal energy source comprising a precursor isotope in secular equilibrium with the progeny thereof, the thermal energy source providing a higher specific energy rate (Watts/gram) than ²³⁸Pu, the precursor isotope comprising ²¹⁰Pb or ²²⁷Ac.

17. The method of claim 16, further comprising using the thermal energy source in a TRISO particle configuration.

18. The method. of claim 16, further comprising using the thermal energy source to power an MMRTG.

19. The method of claim 16, further comprising using the thermal energy source on an unmanned spacecraft.

20. The method of claim 16, wherein the thermal energy source comprises a layered particle comprising a central fuel kernel encased by at least one shell layer, wherein the fuel kernel contains at least a portion of said ²¹⁰Pb or ²²⁷Ac used as a precursor isotope.
